(19) United States
(12) Patent Application Publication
(10) Pub. No.: US 2026/0124706 A1
(43) Pub. Date: May 7, 2026

(54) DUST COLLECTOR FOR ELECTRIC HAMMER

(71) Applicant: Time Master Inc, Louisville, CO (US)

(72) Inventor: Yanhua Xiao, Ji'an Jiangxi (CN)

(73) Assignee: Time Master Inc, Louisville, CO (US)

(21) Appl. No.: 18/935,436

(22) Filed: Nov. 2, 2024

(51) Int. Cl. B23Q 11/00; B25D 16/00

(52) U.S. Cl. CPC B23Q 11/0053; B23Q 11/0071; B25D 16/00

(57) ABSTRACT

A dust collector for electric hammer is disclosed, including a fixed pipe fixedly installed in an opening position, a movable pipe fixedly installed with the electric hammer, and a collection container for collecting dust. A front end of the fixed pipe has a cover body for covering the opening position externally and a drill hole for inserting a drill of the electric hammer, and the drill hole is connected to an interior of the cover body. A front end of the movable pipe is connected to a rear end of the fixed pipe, and the movable pipe is configured to perform a back and forth stretching activity in parallel with a direction of the drill hole with respect to the fixed pipe. The collection container is fixed at a rear end of the movable pipe to connect with the movable pipe.

### TECHNICAL FIELD

The present application relates to the technical field of auxiliary tools for electric hammers, and in particular to a dust collector for electric hammer.

### BACKGROUND

Electric hammer is a widely used electric tool, on the basis of the electric drill, the electric hammer is added a piston with a crankshaft connecting rod driven by an electric motor. As a result, the air in a cylinder is reciprocating compressed, causing the air pressure in the cylinder to change periodically, then the changing air drives the hammer in the cylinder to strike the top of the drill back and forth, which is equivalent to using a hammer to strike the drill, therefore, it is named as electric hammer. The electric hammer is a type of electric drills, mainly used to drill hole in concrete, floor slabs, brick walls, and stone, especially for professional drilling holes in walls, concrete and stone. There are also multifunctional electric hammers that may be adjusted to an appropriate position and equipped with appropriate drills to replace ordinary electric drills and picks.

The current electric hammers would generate a large amount of dust during the process of opening holes, and in existing technologies, the dust can not be effectively collected, resulting in dust flying everywhere and polluting the environment, the operator will also have a negative impact on health after inhalation. Therefore, it is necessary to study a solution to address the aforementioned issues.

### SUMMARY

In view of shortcomings in the existing technologies, the present disclosure aims to provide a dust collector for electric hammer to effectively solve problems of dust flying around during use of the current electric hammers.

To achieve above objectives, the present disclosure adopts the following technical solutions.

In some embodiments of the present disclosure, a dust collector for electric hammer is provided, including a fixed pipe fixedly installed in an opening position, a movable pipe fixedly installed with the electric hammer, and a collection container for collecting dust. Herein a front end of the fixed pipe has a cover body for covering the opening position externally and a drill hole for inserting a drill of the electric hammer, and the drill hole is connected to an interior of the cover body. A front end of the movable pipe is connected to a rear end of the fixed pipe, and the movable pipe is configured to perform a back and forth stretching activity in parallel with a direction of the drill hole with respect to the fixed pipe. The collection container is fixed at a rear end of the movable pipe to connect with the movable pipe.

In some preferred embodiments of the present disclosure, the fixed pipe includes a first straight pipe, a bent pipe and a second straight pipe, and the first straight pipe extends obliquely. The cover body is connected to a front end of the first straight pipe, a front end of the bent pipe is connected to a rear end of the first straight pipe, the second straight pipe extends forward and backward, and a front end of the second straight pipe is connected to a rear end of the bent pipe.

In some preferred embodiments of the present disclosure, the cover body is made of transparent material.

In some preferred embodiments of the present disclosure, the drill hole is located on a back of the cover body.

In some preferred embodiments of the present disclosure, the rear end of the fixed pipe is sleeved with a spring driving the movable pipe to move backwards.

In some preferred embodiments of the present disclosure, the movable pipe is provided with straps bound to the electric hammer for connection.

In some preferred embodiments of the present disclosure, the movable pipe is provided with a shock-absorbing seat abutting on the electric hammer.

In some preferred embodiments of the present disclosure, the collection container is a bottle body and the bottle body is threaded with the rear end of the movable pipe.

The dust collector for electric hammer of the present disclosure has obvious advantages and beneficial effects compared with the existing technologies. Specifically, as can be seen from the above technical solutions, this product consists of the fixed pipe, the movable pipe and the collection container, the cover body of the fixed pipe keeps the opening position being covered and cooperates with the movable pipe to move with the electric hammer, so that effectively collecting dust throughout the entire drilling hole process of the electric hammer, avoiding dust flying around and polluting the environment. And at the same time, the operator will not suck in dust, bringing convenience to the opening operation.

### BRIEF DESCRIPTION OF THE DRAWINGS

FIG. 1 shows a stereoscopic schematic diagram of a dust collector for electric hammer in accordance with some preferred embodiments of the present disclosure.

FIG. 2 shows a cross-sectional view of the dust collector for electric hammer in accordance with some preferred embodiments of the present disclosure.

FIG. 3 shows a stereoscopic schematic diagram of the dust collector for electric hammer in a usage state in accordance with some preferred embodiments of the present disclosure.

In the drawings, reference signs are as follows.

| | | | |
|---|---|---|---|
| 10 | Fixed pipe | 11 | Cover body |
| 12 | First straight pipe | 13 | Bent pipe |
| 14 | Second straight pipe | 101 | Drill hole |
| 20 | Movable pipe | 30 | Collection container |
| 40 | Electric hammer | 41 | drill |
| 51 | strap | 52 | Shock-absorbing seat |
| 53 | spring | | |

### DETAILED DESCRIPTION OF THE EMBODIMENTS

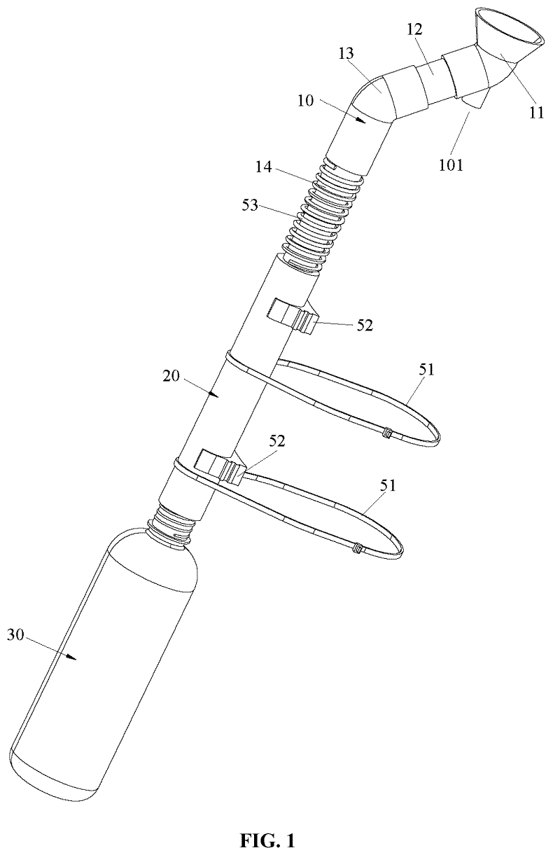

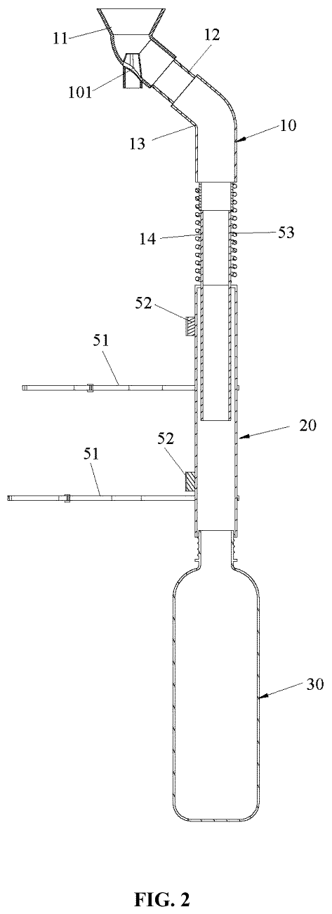

Referring to FIG. 1 to FIG. 3, which shows a specific structure of a dust collector for electric hammer in accordance with some preferred embodiments of the present disclosure. Specifically, the dust collector for electric hammer includes a fixed pipe 10 fixedly installed in an opening position, a movable pipe 20 fixedly installed with the electric hammer 40, and a collection container 30 for collecting dust.

A front end of the fixed pipe 20 has a cover body 11 for covering the opening position externally and a drill hole 101 for inserting a drill 41 of the electric hammer 40, and the drill hole 101 is connected to an interior of the cover body 11. Specifically, the fixed pipe 10 includes a first straight pipe 12, a bent pipe 13 and a second straight pipe 14, and the first straight pipe 12 extends obliquely. The cover body 11 is connected to a front end of the first straight pipe 12, a front end of the bent pipe 13 is connected to a rear end of the first straight pipe 12, the second straight pipe 14 extends forward and backward, and a front end of the second straight pipe 14 is connected to a rear end of the bent pipe 13. In the embodiments of the present disclosure, the cover body 11 is made of transparent material, which can facilitate the operator observe the opening position and also facilitate drilling holes at the prepared location. Moreover, the drill hole 101 is located on a back of the cover body 11.

A front end of the movable pipe 20 is connected to a rear end of the fixed pipe 10, and the movable pipe 20 is configured to perform a back and forth stretching activity in parallel with a direction of the drill hole 101 with respect to the fixed pipe 10. In the embodiments of the present disclosure, the movable pipe 20 has a straight pipe structure, which is fitted onto the rear end of the second straight pipe 14 and maintains communication with the rear end of the second straight pipe 14. And, the movable pipe 20 can move back and forth relative to the second straight pipe 14. Moreover, the movable pipe 20 is provided with straps 51 bound to the electric hammer 40 for connection, so as to facilitate quick installation and fixation of the movable pipe 20 and the electric hammer 40, and the straps 51 is provided with two set at intervals along the axial direction of the movable pipe 20. In addition, the movable pipe 20 is provided with a shock-absorbing seat 52 abutting on the electric hammer 40, to reduce the transmission of vibration to the movable pipe 20. Two sets of the shock-absorbing seat 52 are disposed and spaced apart along the axial direction of the movable pipe 20.

The collection container 30 is fixed to the rear end of the movable pipe 20 and connected to the movable pipe 20. In the embodiments of the present disclosure, the collection container 30 is a bottle body, and the bottle body is fixedly threaded with the rear end of the movable pipe 20, making it easy to disassemble and assemble.

Moreover, the rear end of the fixed pipe 10 is sleeved with a spring 53, which can drive the movable pipe 20 to move backwards and keep the cover body 11 covering the opening position.

The operation method of the dust collector for electric hammer in accordance with embodiments of the present disclosure will be described in detail below.

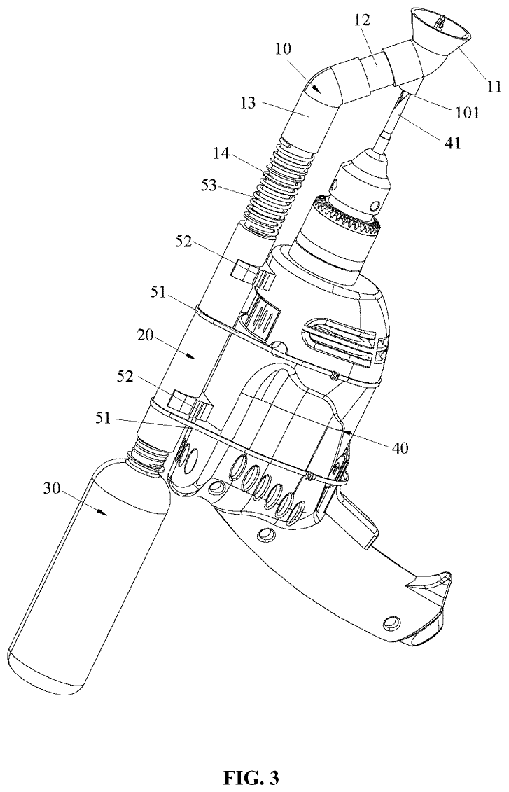

When in use, referring to FIG. 3, the electric hammer 40 is inserted into the drill hole 101 of the drill 41, and the electric hammer 40 is fastened with the movable pipe 20 by means of the straps 51. Next, the drill 41 is placed upwards against the opening position and the cover body 11 covers the opening position externally. Then, the electric hammer 40 is started and an upward force is applied to the electric hammer 40, the drill 41 rotates at high speed and moves upward, thus causing a hole is drilled in the opening position. During the process of opening the hole, the movable pipe 20 moves upwards with the electric hammer 40, while the cover body 11 keeps covering the opening position externally. The dust generated during the process of opening the hole passes through the fixed pipe 10 and the movable pipe 20 under its gravity and falls into the collection container 30 for collection, effectively avoiding the dust flying around and polluting the environment. After opening the hole is completed, the electric hammer 40 is plucked off and this product will leave the opening position with the electric hammer 40. Then, the collection container 30 is dismantled and the dust inside is poured out from the collection container 30.

The design of the dust collector for electric hammer is focus on that, it consists of the fixed pipe, the movable pipe and the collection container, the cover body of the fixed pipe keeps the opening position being covered and cooperates with the movable pipe to move with the electric hammer, so that effectively collecting dust throughout the entire drilling hole process of the electric hammer, avoiding dust flying around and polluting the environment. And at the same time, the operator will not suck in dust, bringing convenience to the opening operation.

The technical principle of the present disclosure is described above in conjunction with specific embodiments. These descriptions are only intended to explain the principles of the present disclosure and cannot be interpreted in any way as limiting the scope of protection of the present disclosure. Based on the explanation herein, one of ordinary skill in the art may be associated with other specific embodiments of the present disclosure without creative labor, and these embodiments shall fall within the scope of protection of the present invention.

What is claimed is:

1. A dust collector for electric hammer, comprising a fixed pipe fixedly installed in an opening position, a movable pipe fixedly installed with the electric hammer, and a collection container for collecting dust;
wherein a front end of the fixed pipe has a cover body for covering the opening position externally and a drill hole for inserting a drill of the electric hammer, and the drill hole is connected to an interior of the cover body;
wherein a front end of the movable pipe is connected to a rear end of the fixed pipe, and the movable pipe is configured to perform a back and forth stretching activity in parallel with a direction of the drill hole with respect to the fixed pipe; and
wherein the collection container is fixed at a rear end of the movable pipe to connect with the movable pipe.

2. The dust collector for electric hammer according to claim 1, wherein the fixed pipe comprises a first straight pipe, a bent pipe and a second straight pipe, and the first straight pipe extends obliquely; and
wherein the cover body is connected to a front end of the first straight pipe, a front end of the bent pipe is connected to a rear end of the first straight pipe, the second straight pipe extends forward and backward, and a front end of the second straight pipe is connected to a rear end of the bent pipe.

3. The dust collector for electric hammer according to claim 1, wherein the cover body is made of transparent material.

4. The dust collector for electric hammer according to claim 1, wherein the drill hole is located on a back of the cover body.

5. The dust collector for electric hammer according to claim 1, wherein the rear end of the fixed pipe is sleeved with a spring driving the movable pipe to move backwards.

6. The dust collector for electric hammer according to claim 1, wherein the movable pipe is provided with straps bound to the electric hammer for connection.

7. The dust collector for electric hammer according to claim 1, wherein the movable pipe is provided with a shock-absorbing seat abutting on the electric hammer.

8. The dust collector for electric hammer according to claim 1, wherein the collection container is a bottle body, and the bottle body is threaded with the rear end of the movable pipe.
